(19) United States
(12) Patent Application Publication
(10) Pub. No.: US 2009/0174159 A1
(43) Pub. Date: Jul. 9, 2009

(54) Xtreme street sled

(76) Inventor: David Arthur Brush, Piedmont, SC (US)

Correspondence Address: David Brush, 21 Hastings Circle, Taylors, SC, 29687, US

(21) Appl. No.: 12/317,817

(22) Filed: Dec. 30, 2008

Related U.S. Application Data
(60) Provisional application No. 61/009,529, filed on Dec. 31, 2007.

(51) Int. Cl. B62B 13/18

(52) U.S. Cl. 280/13

(57) ABSTRACT

The Xtreme Street Sled is a downhill, steerable sled and is a modification of an earlier application (Application No. 11/067,228 filed Feb. 28, 2005 by David A Brush entitled “Street Sled”, copy attached). The components consist of a two-piece metal frame (steel or aluminum) and a fiberglass covering for each frame piece. The front piece has a steering joint attached to a pole that slides into another larger pole firmly attached to the rear frame. The rear frame is fitted for eight skate board wheels and the front frame is fitted for six skate board wheels. The frame is adjustable in length using the fitted pole. The sled is made for the rider to lie prone facing the direction of motion and has handles on the front portion that stick straight up and allow the rider to hold on to each with hands in the “thumbs-up” position and steer.

This downhill, steerable sled is a modification of an earlier application (application Ser. No. 11/067,228 filed Feb. 28, 2005 by David A Brush entitled “Street Sled”, copy attached). The components consist of a two-piece metal frame (steel, aluminum or graphite fiber) and two plastic, fiberglass or graphite fiber coverings for each frame piece. The front piece has a steering joint attached to a pole that slides into another larger pole firmly attached to the rear frame. The rear frame is fitted for eight skate board wheels and the front frame is fitted for six skate board wheels. The frame is adjustable in length whether sitting still or moving by sliding the front and back frames together or farther apart using the fitted poles. The sled is made for the rider to lie prone facing the direction of motion and has handles on the front portion that stick straight up and allow the rider to hold on to each with hands in the “thumbs-up” position.

The rear body section has vertical fins on the right and left sides designed to restrain the rider's legs from sliding off the sled during turns. To steer, the rider merely has to pull on one hand and push on the other for the desired direction.

Below is a miniature of the attached drawing which is on a separate page.

### DRAWING DESCRIPTION

FIG. 1 Slide Bar Assembly

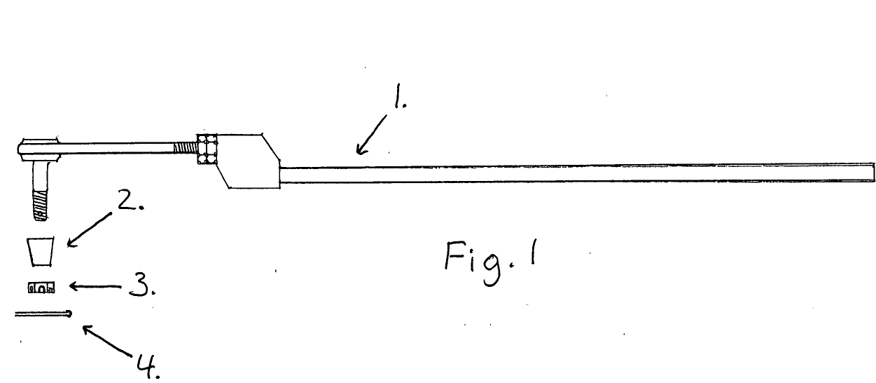

The slide bar assembly consists of a steel or aluminum rod attached to an adapter which mounts to the front blade assembly (FIG. 2). It contains: (1.) slide bar (2.) stainless steel spacer (3.) half inch lock nut (4.) cotter pin.

FIG. 2 Front Blade Assembly

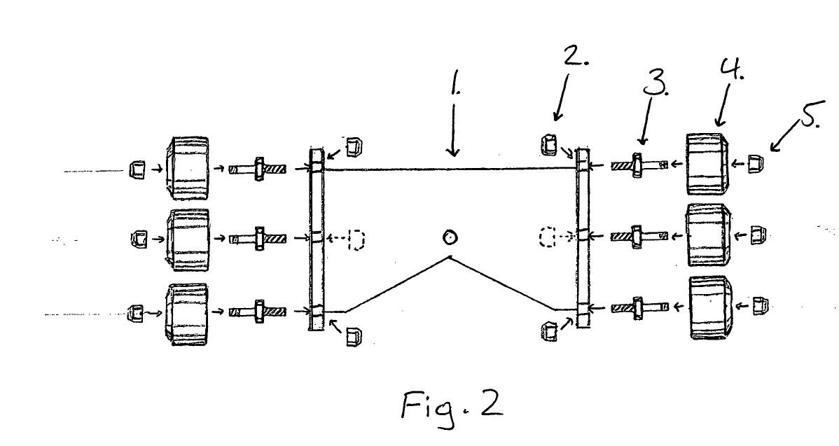

The front blade assembly base consists of a steel plate mounting bracket (FIG. 1) which holds the (3.) wheel axle upon which mounts the (4.) wheel which is held in place by (2.) and (5.) lock nuts. There are 6 wheels on this section.

FIG. 3 Aft Blade Frame Assembly

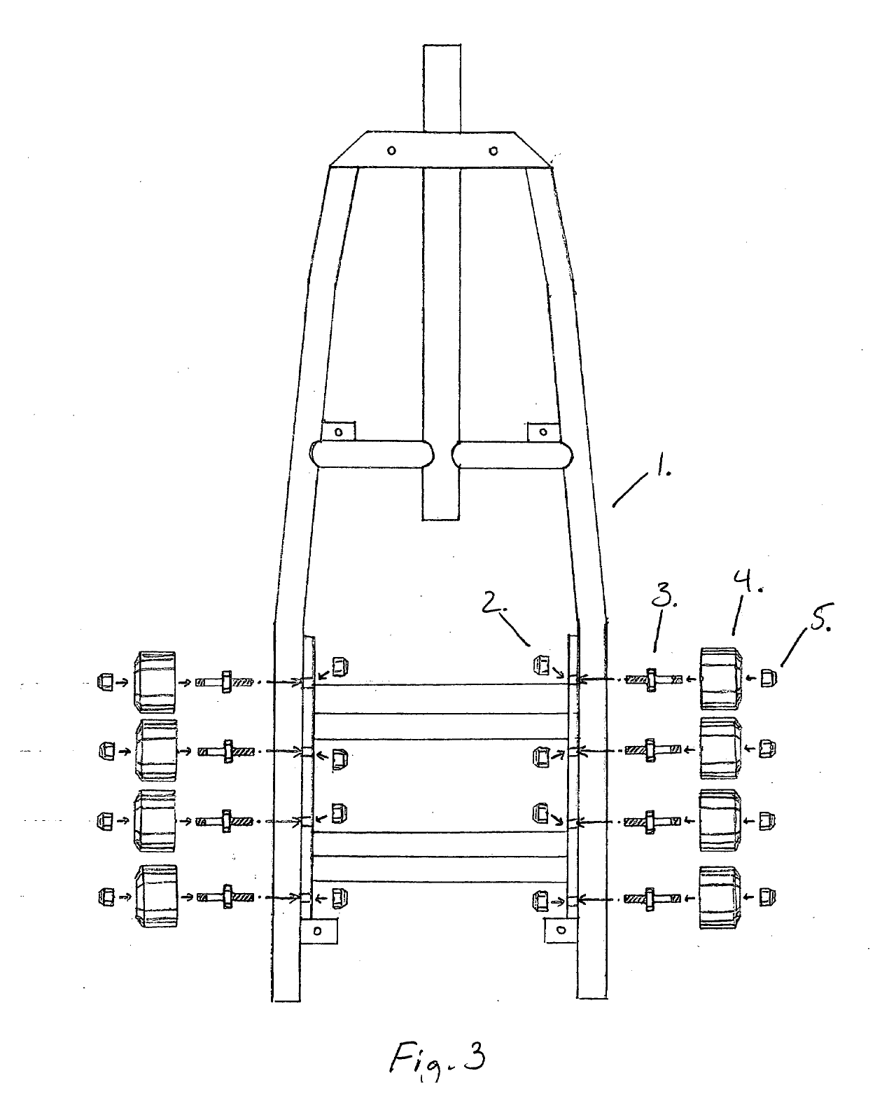

The aft blade frame assembly is composed of a (1.) welded tubular frame which has mounting brackets for the (3.) axles. The (4.) wheels are mounted on the (3.) axles and retained by (2.) and (5.) lock nuts. There are 8 wheels on this section.

I claim:

1. The design of my sled and its frame is unique and offers steering capabilities no other sled of any type can offer.

2. The design of my sled offers stability due to the use of the gyroscopic speed of the wheels at speeds over 60 mph.

3. The strength of the frame can handle stresses no other downhill racer can including the method of stopping by sliding sideways.

4. This sled offers unparalleled safety in the extreme sports because of the positive steering, the strength of the frame and the design of the plastic/fiberglass shell which has the characteristic of restraining the rider from slipping off the sled.

5. The sled is adjustable in length to accommodate the difference in sizes of riders and the variable steering needs of the rider during a downhill run.

6. The sled is equipped to change from wheels for the road to blades for ice or skis for snow.
